(19) United States
(12) Patent Application Publication
(10) Pub. No.: US 2025/0130773 A1
(43) Pub. Date: Apr. 24, 2025

(54) INFERENCE PROCESSING APPARATUS

(71) Applicant: CANON KABUSHIKI KAISHA, Tokyo (JP)

(72) Inventors: TSEWEI CHEN, Tokyo (JP); MASAMI KATO, Kanagawa (JP); TADAYUKI ITO, Kanagawa (JP)

(21) Appl. No.: 18/920,232

(22) Filed: Oct. 18, 2024

(30) Foreign Application Priority Data
Oct. 19, 2023 (JP) 2023-180642

(51) Int. Cl. G06F 7/544; G06F 7/50; G06F 7/523; G06F 7/57

(52) U.S. Cl. CPC G06F 7/5443; G06F 7/50; G06F 7/523; G06F 7/57

(57) ABSTRACT

An inference processing apparatus includes a multiply-accumulate processing unit configured to, in a neural network having a plurality of layers, output a result of multiply-accumulate processing on data of a plurality of feature maps and a 1-bit filter weight, and an adding unit configured to add a correction value for correcting the result of the multiply-accumulate processing to the result of the multiply-accumulate processing, the correction value being independent of the data of the feature maps.

### BACKGROUND

### Field of the Disclosure

The present disclosure relates to processing of a neural network with 1-bit filter weights.

### Description of the Related Art

Deep neural networks (DNN) such as convolutional neural networks (CNN) and vision transformer (ViT) have been attracting attention as high-performance artificial intelligence (AI) algorithms. In a neural network, a plurality of layers is hierarchically connected. Each layer has a plurality of feature maps. A multiply-accumulate (MAC) result is calculated using learned filter coefficients (filter weights) and the pixels (feature data) of the feature maps. The multiply-accumulate operation includes a plurality of multiplications and accumulations. In a CNN, the multiply-accumulate operation is often implemented by a convolution process. The feature maps in the current layer are calculated using the feature maps in the previous layer and the filter weights corresponding to the previous layer. To calculate one feature map in the current layer, information on the plurality of feature maps in the previous layer is required. After multiply-accumulate processing, the result of the multiply-accumulate operation is used to perform activation processing, quantization, pooling, and other processing based on the neural network structure information, thereby calculating the feature map in the current layer.

Because neural networks perform many multiply-accumulate operations, when they are applied to embedded systems such as mobile terminals and in-vehicle devices, it is necessary to perform multiply-accumulate operations efficiently and shorten the overall processing time. As a technique for achieving this, neural networks with a binarized bit width of a filter weight have attracted attention.

Japanese Patent Application Laid-Open No. 2020-060968 discusses an architecture for performing multiply-accumulate operations with binary filter weights using a circuit that calculates an exclusive logical sum (XOR), a subtraction circuit, and a bit shift circuit.

U.S. Pat. No. 10,311,342 discusses an algorithm for calculating multiply-accumulate operations using exclusive negative logical sum (XNOR) with binary filter weights and binary input data.

Compared to conventional networks in which feature data and filter weights are held as real numbers, a network structure in which feature data or filter weights are quantized can be processed with less calculation cost. However, it is necessary to design the computing units to match the bit width of the quantization and the possible values of the filter weights.

The technologies discussed in Japanese Patent Application Laid-Open No. 2020-060968 and U.S. Pat. No. 10,311,342 make it possible to process neural networks with binarized filter weights. Because the calculations in a neural network with filter weight values of ±1 can be performed as an exclusive logical sum (XOR) or a negative exclusive logical sum (XNOR), the calculation cost can be reduced.

In the technology discussed in Japanese Patent Application Laid-Open No. 2020-060968, a circuit for calculating an exclusive logical sum (XOR), a subtraction circuit, and a bit shift circuit are used to perform a multiply-accumulate operation with binary filter weights. The value output from the bit counter needs to be corrected by the subtraction circuit. If the subtraction circuit performs processing with the same degree of parallelism as the multiply-accumulate processing, the circuit size may increase.

The technology discussed in U.S. Pat. No. 10,311,342 is called XNOR-Net, which makes it possible to perform multiply-accumulate operations with binary filter weights and binary input data using negative exclusive logical sum (XNOR).

In the technology discussed in U.S. Pat. No. 10,311,342, both the input data and the filter weight are 1 bit. An XNOR-Net in which the input data and the filter weight are both 1 bit cannot be directly applied to a network in which the bit width of the input data is increased to improve the recognition accuracy by inference. In the technology discussed in U.S. Pat. No. 10,311,342, the input data and the filter weight are both 1 bit to reduce the circuit size. However, because the amount of information in the network is less than that in the case where the bit width of the input data is 2 bits or more, there is a possibility that the recognition accuracy will be lower.

In order to increase the accuracy of algorithms such as ViT, not only filter weights with values of ±1 but also filter weights with values of 0 and +1 are necessary. The technologies discussed in Japanese Patent Application Laid-Open No. 2020-060968 and U.S. Pat. No. 10,311,342 make it possible to process neural networks with filter weight values of ±1, but do not make it possible to process neural networks with filter weight values of 0 and +1.

### SUMMARY

The present disclosure is directed to reducing the circuit size for performing a multiply-accumulate operation on feature data of 2 bits or more using a 1-bit filter weight.

According to an aspect of the present disclosure, an inference processing apparatus includes a multiply-accumulate processing unit configured to, in a neural network having a plurality of layers, output a result of multiply-accumulate processing on data of a plurality of feature maps and a 1-bit filter weight, and an adding unit configured to add a correction value for correcting the result of the multiply-accumulate processing to the result of the multiply-accumulate processing, the correction value being independent of the data of the feature maps.

Further features of the present disclosure will become apparent from the following description of exemplary embodiments with reference to the attached drawings.

### BRIEF DESCRIPTION OF THE DRAWINGS

FIG. 1 is a flowchart of neural network processing.

FIG. 2 is a diagram illustrating an example of a structure of a network to be processed.

FIG. 3 is a block diagram illustrating an architecture example of an inference processing apparatus.

FIG. 4 is a block diagram of an inference unit.

FIG. 5 is a block diagram of a multiply-accumulate unit.

FIG. 6 is a diagram illustrating an example of a relationship between the network and convolution processing.

FIG. 7 is a diagram illustrating an example of a relationship between a correction unit and the multiply-accumulate unit.

FIG. 8 is a flowchart of neural network processing.

FIG. 9 is a block diagram of an inference unit.

FIG. 10 is a diagram illustrating an example of a relationship between the network and convolution processing.

FIG. 11 is tables illustrating a relationship between modes and multiplications.

FIG. 12 is a diagram illustrating an example of a multiplier.

FIG. 13 is a diagram illustrating an example of a multiplier.

FIG. 14 is a diagram illustrating an example of feature data with a width of 8 bits.

### DESCRIPTION OF THE EMBODIMENTS

A first exemplary embodiment of the present disclosure will be described in detail with reference to the drawings.

### <Architecture Example of Inference Processing Apparatus>

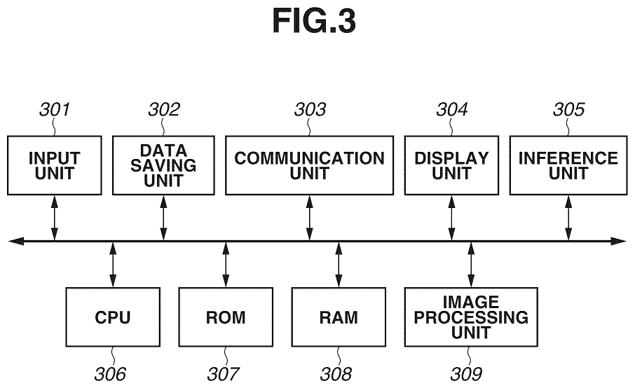

FIG. 3 is a block diagram illustrating an architecture example of an inference processing apparatus according to the present disclosure.

A data saving unit 302 is a unit that saves image data. The data saving unit 302 usually includes a hard disk, a flexible disk, a compact disc-read only memory (CD-ROM), a CD recordable (CD-R), a digital versatile disk (DVD), a memory card, a compact flash (CF) card, smart media, a secure digital (SD) card, a memory stick, an xD picture card, a universal serial bus (USB) memory, or the like. The data saving unit 302 can also save programs and other data in addition to image data. Alternatively, a part of a random access memory (RAM) 308 described below may be used as the data saving unit 302. Alternatively, the data saving unit 302 may be configured virtually such that a storage unit of a device connected via a communication unit 303 described below is used via the communication unit 303.

A display unit 304 is a device for displaying images before and after image processing or images of a graphic user interface (GUI) or the like, and a cathode-ray tube (CRT) display, a liquid crystal display, or the like, are generally used. Alternatively, the display unit 304 may be an external display device connected via a cable or the like.

An input unit 301 is a device for the user to input instructions and data, and includes a keyboard, a pointing device, buttons, and the like.

Alternatively, the display unit 304 and the input unit 301 may be the same device, as in known touch screen devices. In that case, an input via the touch screen is treated as an input via the input unit 301.

A central processing unit (CPU) 306 controls the entire operation of the apparatus. The ROM 307 and the RAM 308 provide the CPU 306 with programs, data, work areas, and the like required for the processing. In a case where the programs required for the processing described below are stored in the data saving unit 302 or in the ROM 307, the programs are first read into the RAM 308 and then executed. Alternatively, in a case where the apparatus receives the program via the communication unit 303, the programs are first recorded in the data saving unit 302 and then read into the RAM 308, or the programs are directly read from the communication unit 303 into the RAM 308 and then executed.

An image processing unit 309 receives a command from the CPU 306, reads out the image data from the data saving unit 302, adjusts the range of the pixel values, and writes the result back into the RAM 308.

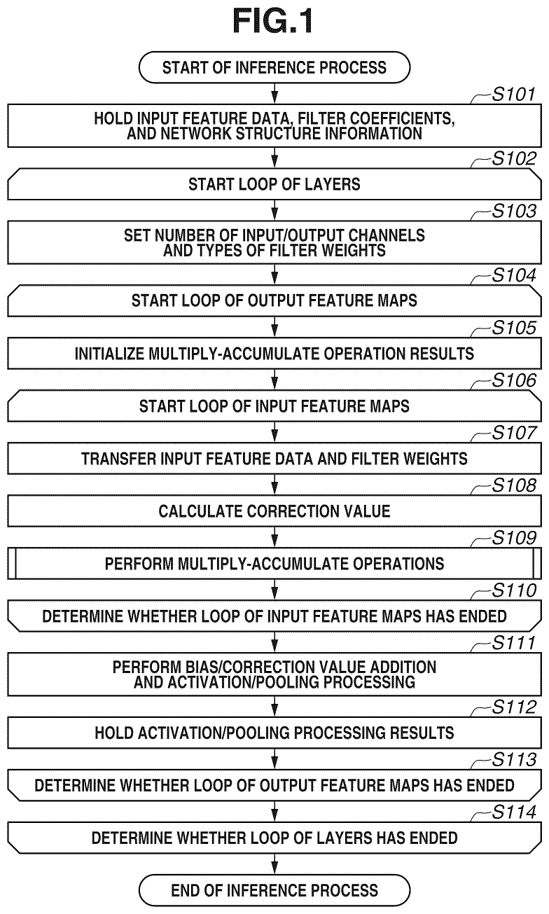

The inference unit 305 performs an inference process (steps S101 to S114) including multiply-accumulate operations using the image processing results saved in the RAM 308 in accordance with the flowchart of FIG. 1 described below, and outputs the processed results to the data saving unit 302 (or the RAM 308).

Based on the result of the neural network processing, the CPU 306 performs image processing or image recognition of the moving image (in the case of a plurality of frames). The result of the image processing or image recognition performed by the CPU 306 is saved in the RAM 308.

Referring to FIG. 3, only one CPU (CPU 306) is provided. However, a plurality of CPUs may be provided. The processing unit is not limited to a CPU, and may be a graphics processing unit (GPU) or a neural processing unit (NPU).

The communication unit 303 is an interface (I/F) for communication between devices. FIG. 3 illustrates the input unit 301, the data saving unit 302, and the display unit 304 that are all included in one apparatus. Alternatively, these units may be connected by a communication path using a known communication method to form the entire architecture.

The system architecture of the apparatus includes various components in addition to those described above, but as they are not the focus of the present disclosure, description thereof will be omitted.

### <Processing Target Network>

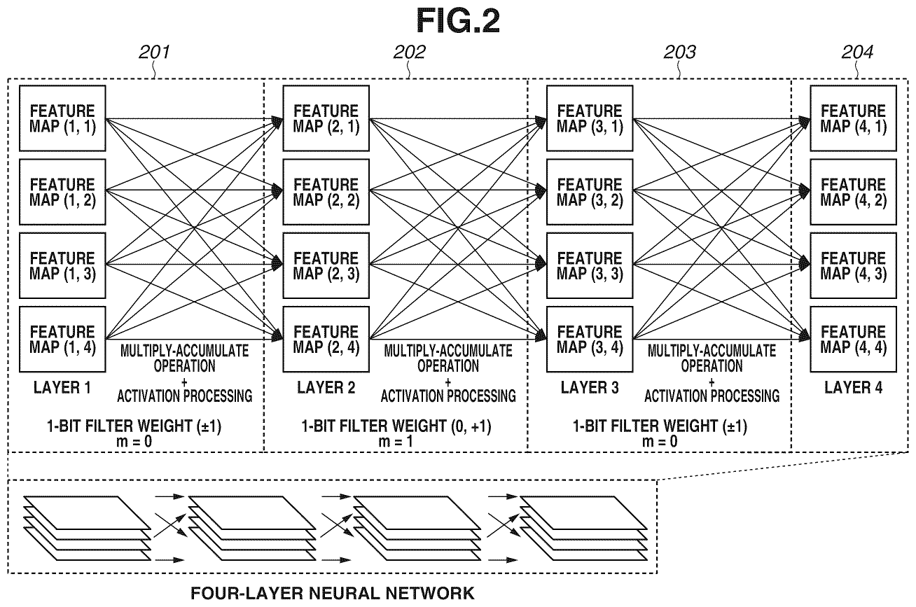

FIG. 2 illustrates an example of a structure of a processing target neural network. The arrows represent multiply-accumulate operations, quantization, activation processing, and the like.

The network structure includes information about layers (inter-layer connection relationships, filter structure, feature map size, bit width, number, filter weights, and the like). This network has four layers (layers 1 to 4), each of which includes four feature maps, and each feature map contains a plurality of pixels of feature data. The filters and the plurality of pixels of feature data are structured hierarchically. The number of feature maps in each layer is not limited to four, and any number of feature map can be used. For example, the layer 1 may be a red-green-blue (RGB) format image with three maps.

FIG. 2 illustrates the bit width of the filter weights for the layers of the process target network. All the filter weights are of 1 bit, and there are two possible values for the 1 bit. Two of the three types of filter weights are set according to the mode (variable m). When the mode is 0, the value of the filter weight is −1 or +1. When the mode is 1, the value of the filter weight is 0 or +1. Providing two modes increases the number of values of filter weight processed in the network to three, −1, 0, and +1, which enhances the expressiveness of information and improves the accuracy of recognition by inference. If there are only two types of values of filter weight, ±1, the filter weight that would be learned as 0 when there are three types of values of filter weight is approximated to either of ±1, which is one of the factors that reduces the accuracy of inference.

The calculation of the layers 1 to 4 will be described. In the layer 1 (m=0), multiply-accumulate operation results are calculated using a plurality of feature maps 201 and filter weights with a value of −1 or +1 based on Equation 1 described below, thereby a plurality of feature maps 202 in the layer 2 is generated. In the layer 2 (m=1), multiply-accumulate operation results are calculated using the plurality of feature maps 202 and filter weights with a value of 0 or +1 based on Equation 1, thereby a plurality of feature maps 203 in the layer 3 is generated.

In the layer 3 (m=0), multiply-accumulate operation results are calculated using the plurality of feature maps 203 and filter weights with a value of −1 or +1 based on Equation 1 to generate a plurality of feature maps 204 in the layer 4.

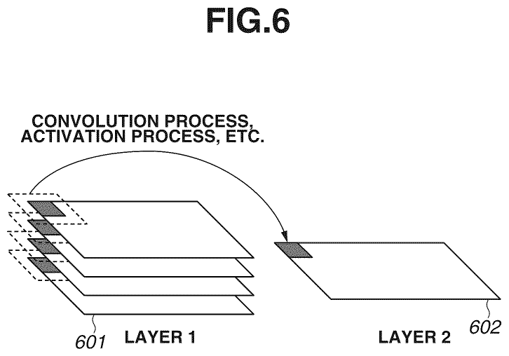

FIG. 6 illustrates an example of a network and convolutional operation processing. Feature data is extracted from the same positions in four feature maps 601 in the layer 1, and multiply-accumulate processing is performed to calculate the result of activation processing. The result constitutes feature data of image 602 at the same position in the layer 2. The network processing is not limited to convolutional processing, and may include matrix operations and other multiply-accumulate processing.

### <Flowchart of Neural Network Processing in Present Disclosure>

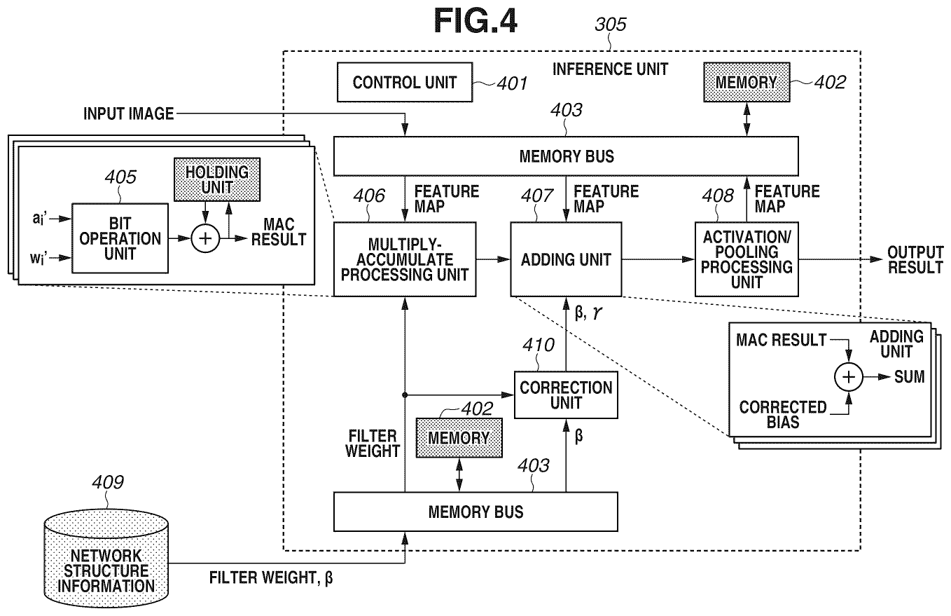

FIG. 4 illustrates an architecture of the inference unit 305. The inference unit 305 includes a control unit 401, a memory 402, a memory bus 403, a multiply-accumulate processing unit 406, an adding unit 407, an activation/pooling processing unit 408, and a correction unit 410.

The multiply-accumulate processing unit 406 includes a plurality of bit operation units (1-bit logical operation circuits) 405. The multiply-accumulate processing unit 406 calculates the multiplication results and the accumulation result of the multiplication results, and outputs the

multiply-accumulate operation result. In order to reduce the circuit size for multiplication processing, in the present exemplary embodiment, the multiplication processing is performed by 1-bit logical operation circuits instead of a multiplier that performs multi-bit operations. However, because an operation using the filter weight −1 is processed by a logical operation of 0 and 1, correction is required in post-processing using a correction value. Details will be described below.

The multiply-accumulate processing unit 406 calculates multiply-accumulate operation results from the filter weights and feature data based on Equation 1 described below. The filter weights input to the multiply-accumulate processing unit 406 have a 1-bit width. The activation/pooling processing unit 408 calculates the activation/pooling processing results based on the multiply-accumulate operation results.

Each step in the flowchart illustrated in FIG. 1 will be described based on the architecture of the inference unit 305 illustrated in FIG. 3. Steps S101 to S114 are control operations by the CPU or the sequencer included in the control unit 401.

In step S101, the control unit 401 reads out pixels (feature data) of a plurality of input feature maps or pixels of an input image, filter weights, and network structure information 409 from the RAM 308, and stores them in the memory 402 through the memory bus 403.

In step S102, the control unit 401 starts a loop of layers and processes the first layer (layer 1). The layer 1 is a processing target layer.

In step S103, the control unit 401 sets the number of input/output channels (the number of feature maps) and the types of filter weights according to the network structure information 409 held in the memory 402. In this example, the bit widths of filter weights in the same layer are all 1 bit, and there are two types of filter weights.

In step S104, the control unit 401 starts a loop of the output feature maps and calculates the output feature data in order.

In step S105, the control unit 401 performs initialization by setting the multiply-accumulate operation results held in the multiply-accumulate processing unit 406 to zero.

In step S106, the control unit 401 starts a loop of the input feature maps, and processes the input feature data in order.

In step S107, the control unit 401 reads out some of the input feature maps from the memory 402, and transfers them to the feature data holding unit 402. Then, the control unit 401 reads out some of the filter weights from the memory 402, and transfers them to the correction unit 410 and the multiply-accumulate processing unit 406.

In step S108, the correction unit 410 receives a control signal from the control unit 401 and calculates a correction value that is not dependent on the feature maps. The calculation formula for the multiply-accumulate operation (Equation 1) can be divided into a part that is dependent on the feature maps and a part that is not dependent on the feature maps (Equation 4). The correction value is the calculation result of the part that is not dependent on the feature maps. The correction value can be calculated independently of the multiply-accumulate processing of the feature maps and the filter weights. The main purpose of the inference processing apparatus is not to perform network training, but to perform an inference process, and the input image and the feature maps are updated more frequently than the filter weights. In many cases, even if the input image for the inference processing changes, a common filter weight is used. In the case of using a common filter weight, the calculation of the correction value, which is not dependent on the feature maps, is processed by a circuit with a different calculation efficiency from that of the calculation that is dependent on the feature maps, thereby making it possible to reduce the calculation cost. The circuit size can be reduced by decreasing the parallelism of the circuit that calculates the correction value that is not dependent on the feature maps. The calculation formula for the correction value is Equation 5 described below.

In step S109, the multiply-accumulate processing unit 406 receives a control signal from the control unit 401 and calculates a multiply-accumulate operation result based on the held input feature data, filter weight, and the type of the filter weight (mode represented by a variable m) using Equation 1. In Equation 1, “otherwise” means the case where m=1.

$$output = \{ \begin{matrix}{\sum }_{i = 0}^{i - 1} {a}_{i}^{′} {w}_{i} + β & if m = 0 \\ {\sum }_{i = 0}^{i - 1} {a}_{l}^{′} {w}_{l} + β & otherwise\end{matrix} \qquad ( Equation 1 )$$

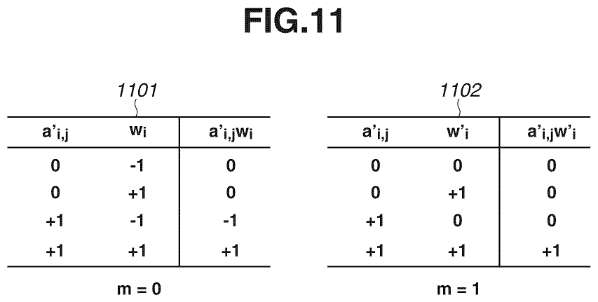

FIG. 11 illustrates tables of the relationship between mode and multiplication. A variable a′ is a pixel of the feature map and is a multi-bit variable. A variable a′_{i,j} is a part of the pixel of the feature map divided into 1 bit and has a value of 0 or 1. The variables w′ and w are filter weights and are selected according to the value of the variable m. If the variable m is set to 0, the filter weight w with a value of −1 or +1 is used as in table 1101. If the variable m is set to 1, the filter weight w′ with a value of 0 or +1 is used as in table 1102. When two types of binary filter weights are used in different layers of the same network, three types of filter weights are used in the entire network, which can improve the recognition accuracy by inference. A variable i is an index for multiply-accumulate processing, and there are I pixels and I filter weights. A variable β is a bias value (or offset value) used in normalization or quantization.

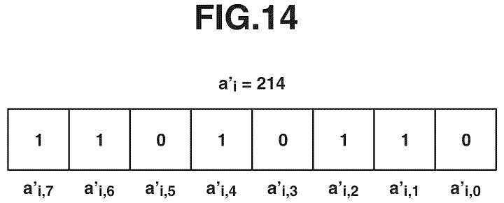

A pixel (feature data) of the feature map has J bits, and the filter weight has 1 bit. The feature data and the filter weight are different in bit width. FIG. 14 illustrates an example of feature data with a width of 8 bits (J=8). When decimal feature data a′ᵢ with a value of 214 is converted to binary, it has an 8-digit value (11010110). That is, the feature data a′ᵢ can be expressed with 8 bits (a′_{i,0}, a′_{i,1}, . . . , a′_{i,7}). The variables a′_{i,j} mean the bit of each digit. The variable a′_{i,0} is the least significant bit and has a value of 0. The variable a′_{i,7} is the most significant bit and has a value of 1. In this example, a sign bit is not included in the 8-bit feature data.

If the variable m is 0, the first type of binary filter weight is selected. In the case of expressing the pixel a′ of the feature map by J-bit data, the multiply-accumulate processing in Equation 1 can be expressed by Equation 2:

$${\sum }_{i = 0}^{i - 1} {a}_{i}^{′} {w}_{i} + β = {\sum }_{j = 0}^{J - 1} ( {2}^{j} {\sum }_{i = 0}^{i - 1} {a}_{i , j}^{′} \cdot {w}_{i} ) + β \qquad ( Equation 2 )$$

The variable a′_{i,j} is a part of the pixel of the feature map divided into 1 bit, and has a value of 0 or 1. The variable j is the index of the bit of the pixel. For example, when J=8, data of 0 or 1 is multiplied by the filter weight and bit operation in order from the 0th digit to the 7th digit (j=0 to 7), and shifted from the 0th power of 2 to the 7th power of 2, and accumulated. The accumulation operation in the parentheses in Equation 2 is the multiply-accumulate of 1-bit data and 1-bit filter weight. At calculations in a digital circuit, data is stored as 0 and 1, so it is necessary to express the filter weight w′ with a value of −1 or +1 as the filter weight w with a value of 0 or +1. The accumulation operation in the parentheses in Equation 2 can be rewritten as Equation 3:

$$\begin{matrix}{\sum }_{i = 0}^{l - 1} {a}_{i , j}^{′} {w}_{i} = {\sum }_{i = 0}^{l - 1} [ \frac{( 2 {a}_{i , j}^{′} - 1 ) + 1}{2} ] {w}_{i} \\ = {\sum }_{i = 0}^{i - 1} \frac{( {a}_{i , j} \cdot {w}_{i} + {w}_{i} )}{2} \\ = \frac{2 {\sum }_{i = 0}^{l - 1} ( {a}_{i , j}^{′} ⊙ {w}_{i}^{′} ) - {\sum }_{i = 0}^{l - 1} 1 + {\sum }_{i = 0}^{l - 1} {w}_{i}}{2} \\ = {\sum }_{i = 0}^{l - 1} ( {a}_{i , j}^{′} ⊙ {w}_{i}^{′} ) + \frac{{\sum }_{i = 0}^{l - 1} {w}_{i} - l}{2}\end{matrix} \qquad ( Equation 3 )$$

The variable a_{i,j} is a part of the pixel of the feature map and has a value of −1 or 1. The variable a_{i,j} is used as an intermediate variable.

An operator ⊙ means exclusive negative logical sum (XNOR). Substituting the result of Equation 3 into Equation 2 makes it possible to express the multiplication of a multi-bit pixel (synonymous with feature data of 2 or more bits) and a 1-bit filter weight by Equation 4:

$$\begin{matrix}{\sum }_{j = 0}^{J - 1} [ {2}^{j} {\sum }_{i = 0}^{i - 1} ( {a}_{i , j}^{′} ⊙ {w}_{i}^{′} ) ] + {\sum }_{j = 0}^{J - 1} {a}_{i , j}^{′} \cdot {w}_{i} [ {2}^{j} \cdot \frac{{\sum }_{i = 0}^{l - 1} ( {w}_{i} - J )}{2} ] + β \\ = {\sum }_{j = 0}^{J - 1} [ {\sum }_{j = 0}^{J - 1} ( {2}^{i} \cdot {a}_{i , j}^{′} ⊙ {w}_{i}^{′} ) ] + ( β + γ )\end{matrix} \qquad ( Equation 4 )$$

Because the multiply-accumulate processing can be substituted by a bit logical operation and addition of XNOR, there is no need to provide a multiplier, and the circuit size can be reduced. The variable γ, which is not dependent on the feature maps, has the correction value that is calculated by Equation 5:

$$γ = ( \frac{{\sum }_{i = 0}^{l - 1} {w}_{i} - l}{2} ) \cdot ( {2}^{J} - 1 ) \qquad ( Equation 5 )$$

Because the correction value γ is calculated only using the filter weight and does not change depending on the pixel values of the feature maps, the correction value γ can be calculated separately from the multiply-accumulate processing. That is, the common correction value is used in the multiply-accumulate processing for pixels of a plurality of feature maps.

In step S108, the correction unit 410 receives a control signal from the control unit 401 and calculates the correction value γ.

When the variable m is 1, the second type of binary filter weight is selected. In the case of expressing the pixel a′ of the feature map by J-bit data, the multiply-accumulate processing in Equation 1 can be expressed by Equation 6. Unlike in the case where the variable m is 0, the multiplication can be substituted with logical product (AND), so the correction value is 0.

$${\sum }_{i = 0}^{l - 1} {a}_{i}^{′} {w}_{i}^{′} + β = {\sum }_{i = 0}^{l - 1} [ {\sum }_{j = 0}^{J - 1} ( {2}^{j} \cdot {a}_{i , j}^{′} \cdot {w}_{i}^{′} ) ] + β \qquad ( Equation 6 )$$

In the table 1102 of FIG. 11, the variable a′ is a pixel of the feature map and has a plurality of bits. The variables a′_{i,j} is a part of the pixel of the feature map divided into 1 bit, and has a value of 0 or 1. The variable w′ is a filter weight and has a value of 0 or 1. The variable i is an index for multiply-accumulate processing, and there are I pixels and I filter weights. The variable β is a bias value for normalization or quantization.

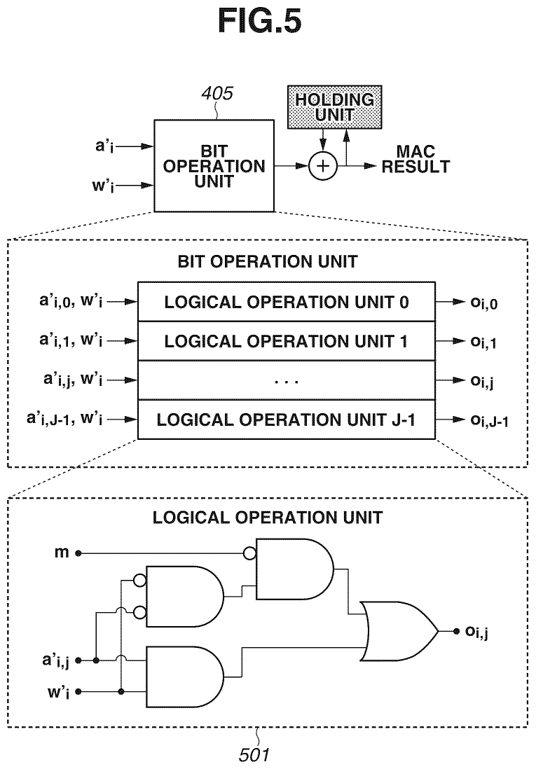

FIG. 5 illustrates a structure of the bit operation unit 405. The structure is illustrated step-by-step in detail. The bit operation unit 405 includes a plurality of (J) logical operation units, and combines the respective output results of the logical operation units and outputs the result of a bitwise operation (operation for each bit). The output of the logical operation unit varies depending on the value of the variable m. If the variable m is 0, the result of the XNOR operation in Equation 4 is output from the logical operation unit. If the variable m is 1, the result of the AND operation in Equation 6 is output from the logical operation unit.

In step S110, the control unit 401 determines whether the loop of the input feature maps has ended. If all the input feature data has been processed, the process proceeds to step S111. If not, the process returns to step S107. In step S107, processing of the next input feature map is started.

In step S111, the multiply-accumulate processing unit 406 transfers the multiply-accumulate operation result to the adding unit 407. The adding unit 407 receives a control signal from the control unit 401 and calculates the sum of the correction value γ in Equation 4, the bias β in Equation 4 or Equation 6, and the multiply-accumulate operation result. Then, the activation/pooling processing unit 408 receives a control signal from the control unit 401 and performs activation processing based on the result of the multiply-accumulate operation in Equation 4 held in the adding unit 407. The activation processing result is calculated using Equation 7:

$$f ( x ) = \{ \begin{matrix}0 , & x < 0 \\ x , & x \geq 0\end{matrix} \qquad ( Equation 7 )$$

In Equation 7, f(⋅) is the activation function, and x is the input data (output from the adding unit 407). The activation process result is converted into a J-bit feature map. In this example, the activation function is implemented using a Rectified Linear Unit (ReLU), but it is not limited to ReLU. Other nonlinear functions or quantization functions that quantize the multiply-accumulate operation results, correction values, and bias values into J bits can also be used to implement the activation function.

The activation/pooling processing unit 408 performs pooling based on the result of the activation processing according to the layer information, and adjusts the size of the output feature map if necessary.

In step S112, the control unit 401 holds the activation/pooling processing result in the feature data holding unit 402, and handles the same as a feature map of the next layer.

In step S113, the control unit 401 determines whether the loop of the output feature maps has ended. If all the output feature maps have been processed, the process proceeds to step S114. If not, the process returns to step S105. In step S105, processing of the next output feature map is started.

In step S114, the control unit 401 determines whether the loop of layers has ended. If all the layers have been processed, the processing of the neural network is ended. If not, the process returns to step S103. In step S103, the processing target layer is changed, and processing of the next layer is started.

In the present exemplary embodiment, the multiply-accumulate operations of pixels (feature data) of a plurality of bits (J bits) and 1-bit filter weights can be efficiently performed by using a circuit architecture in which the calculation of the correction value γ is separated from the multiply-accumulate operations. Because a network including three types of filter weights with values of 0 and ±1 can be processed, it is possible to process a network with higher information expression power and improve recognition accuracy. Furthermore, because a network including filter weights with values of 0 and ±1 can be processed with the same circuit architecture, the circuit size can be reduced.

### <Adjustment of Parallelism>

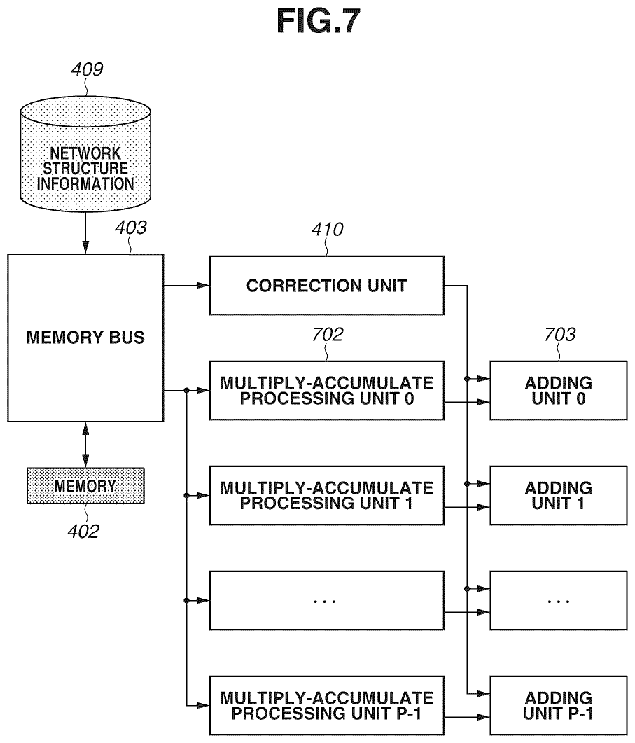

FIG. 7 illustrates an example of the correction unit 410 and multiply-accumulate processing units 702 different in parallelism. There are one correction unit 410, and P multiply-accumulate processing units 702, and P adding units 703. The multiply-accumulate processing units 702 have the same function as the multiply-accumulate processing unit 406, and the adding units 703 have the same function as the adding unit 407. As in the architecture illustrated in FIG. 4, the multiply-accumulate processing units 702 transfer the multiply-accumulate processing results to the adding units 703. P pixels of feature data and one common filter weight are read via the memory bus 403, and then the processing units 702 and the adding units 703 calculate the P pixels of feature data and one filter weight in parallel. In order to improve the processing speed, it is necessary to increase the parallelism of the circuit that performs multiply-accumulate processing on a plurality of pixels, but it is not necessary to increase the parallelism of the circuit that calculates the correction value. Separating the calculation of the correction value and the multiply-accumulate processing produces an advantageous effect that the circuit size for the multiply-accumulate processing with high parallelism can be reduced. For an embedded device such as a digital camera, the reduction in the circuit size is desirable.

### <Calculation of Correction Value Before Inference Process>

A second exemplary embodiment will be described. In the first exemplary embodiment, the correction value is calculated in step S108 as an example. Alternatively, the correction value may be calculated before the start of inference. The hardware architecture in the second exemplary embodiment is the same as that in the first exemplary embodiment, so description thereof will be omitted.

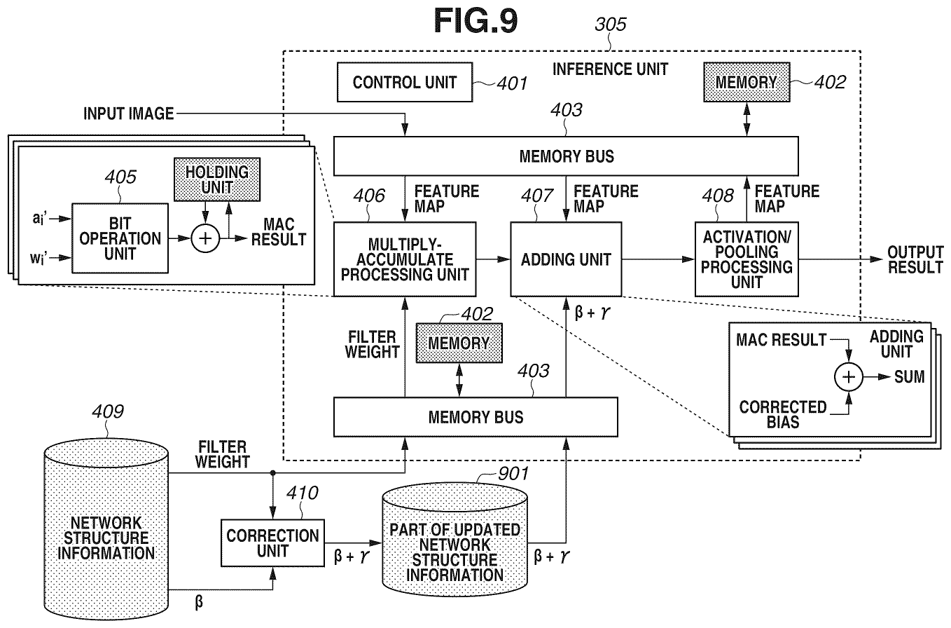

FIG. 9 illustrates an architecture of the inference unit 305. The inference unit 305 includes the control unit 401, the memory 402, the memory bus 403, the multiply-accumulate processing unit 406, the adding unit 407, and the activation/pooling processing unit 408. The inference unit 305 does not include the correction unit 410. The CPU 306 illustrated in FIG. 3 performs the function of the correction unit 410.

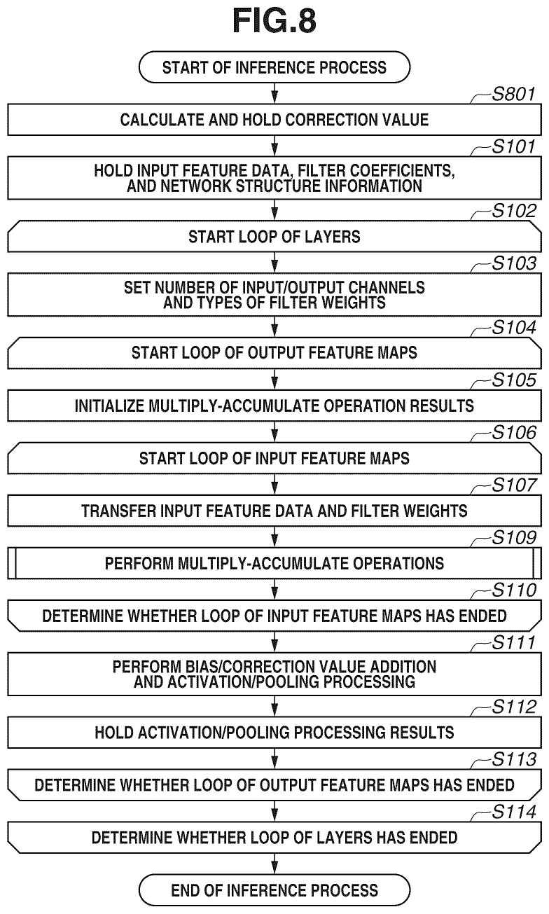

The steps in the flowchart illustrated in FIG. 8 will be described based on the architecture of the inference unit 305 illustrated in FIG. 9. The steps different from those of the first exemplary embodiment will be described.

In step S801, the correction unit 410 receives a control signal from the control unit 401, reads out a filter weight and network structure information 409 from the RAM 308, and calculates the correction value γ according to Equation 5. Then, the correction unit 410 calculates the sum of the correction value γ and the bias β, and replaces the bias β with this sum. The correction unit 410 holds an updated bias β′ in the memory 402 as a part 901 of the new network structure. The value of the updated bias β′ is calculated using Equation 8. The value of the updated bias β′ varies depending on the mode of the filter weight (variable m).

$${β}^{′} = \{ \begin{matrix}β + γ , & m = 0 \\ β , & otherwise\end{matrix} \qquad ( Equation 8 )$$

Since the correction value is included in the updated bias β′, step S108 in the first exemplary embodiment is deleted. There is no need to calculate the correction value again before performing multiply-accumulate processing in step S109.

In step S101, the control unit 401 reads out feature data of a plurality of input feature maps, filter weights, the network structure information 409, and the part 901 of the new network structure from the RAM 308, and stores them in the memory 402 through the memory bus 403.

In step S111, the adding unit 407 receives a control signal from the control unit 401 and calculates the sum of the updated bias (corrected bias) β′ in Equation 8 and the multiply-accumulate operation results.

In the present exemplary embodiment, the correction value is calculated before the inference process and is held in advance in the RAM 308. Deleting the circuit for calculating the correction value from the inference unit 305 makes it possible to reduce the power consumption and the circuit size.

### <Applications of Neural Network>

In the first and second exemplary embodiments, the inference processing apparatus is applied to image processing. However, the inference processing apparatus may also be applied to applications other than image processing (such as speech recognition).

### <Non-Two-Dimensional Data>

In the first exemplary embodiment, the present disclosure is applied to a neural network for two-dimensional image data. However, the present disclosure may also be applied to a neural network for one-dimensional audio data or any three- or higher-dimensional data.

### <XOR (Exclusive Logical Sum)>

In the first and second exemplary embodiments, as an example, multiply-accumulate processing can be substituted by a XNOR bit logical operation and an addition. However, because XNOR can be decomposed into NOT (logical inverse), the bit logical operation can be achieved by a combination of XOR (exclusive logical sum) and NOT (logical inverse).

### <Addition of Correction Value>

In the first exemplary embodiment, in step S111, the adding unit 407 receives a control signal from the control unit 401 and calculates the sum of the multiply-accumulate operation result and the correction value in accordance with Equation 4. However, this is not limited to the operation performed by the adding unit 407. Equation 4 can be rewritten as Equation 9. The part of the equation other than the calculation of XNOR and the addition of the bias β corresponds to the calculation of the correction value. The calculation of the correction value may be partially performed by the multiply-accumulate processing unit 406.

$${\sum }_{i = 0}^{l - 1} [ {\sum }_{j = 0}^{J - 1} ( {2}^{j} \cdot {a}_{i , j}^{′} ⊙ {w}_{i}^{′} ) + {\sum }_{j = 0}^{J - 1} {2}^{j} \cdot ( \frac{{w}_{i} - 1}{2} ) ] + β \qquad ( Equation 9 )$$

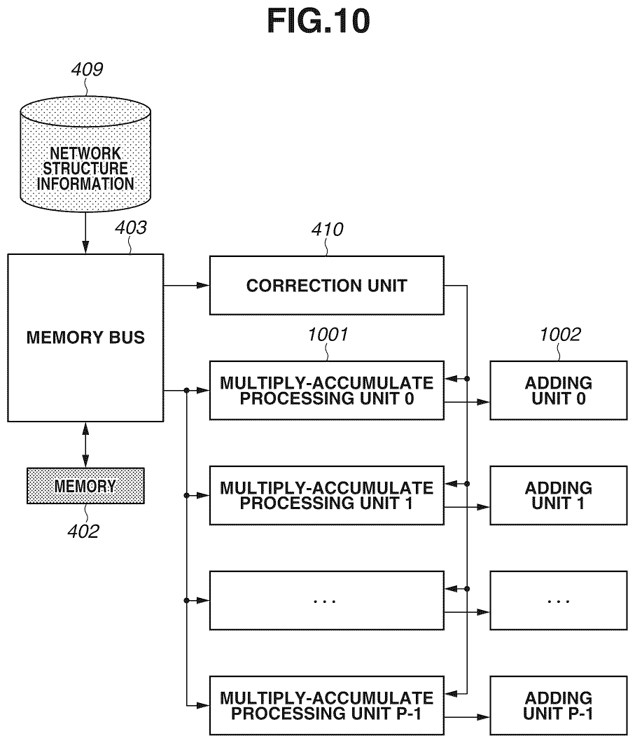

FIG. 10 illustrates an example of a correction unit 410 and multiply-accumulate processing units 1001 different in parallelism as in the first exemplary embodiment. There are one correction unit 410, and P multiply-accumulate processing units 1001 and P adding units 1002. Unlike in the example in FIG. 6, the correction value is transferred to the multiply-accumulate processing units, not to the adding units.

Even if the parallelism of the circuit for performing the multiply-accumulate processing of a plurality of pixels is increased, it is not necessary to increase the parallelism of the circuits for calculating the correction value. Separating the calculation of the correction value from the multiply-accumulate processing makes it possible to reduce the circuit size for the multiply-accumulate processing with a high degree of parallelism.

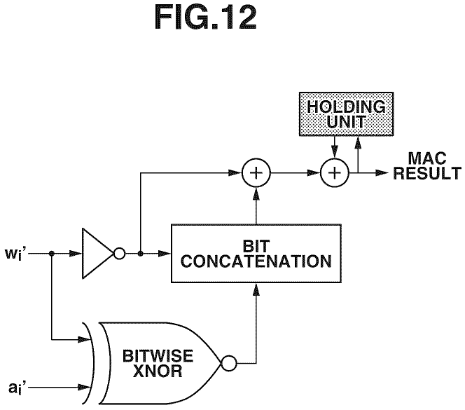

FIG. 12 illustrates a modification example of the multiplication processing. The operation result of bitwise XNOR of a filter weight and feature data is calculated and bit-concatenated with a logically inverted 1-bit filter weight. Then, the sum of the result of the bit-concatenation with the logically inverted 1-bit filter weight is calculated, and accumulation is performed. In the multiplication processing of the first exemplary embodiment illustrated in FIG. 5, no correction value is calculated, but in the multiplication processing illustrated in FIG. 12, a correction value is calculated.

The calculation result of Equation 9 can be output.

### <Changing Bit Operation to Multiplier or Multiplexer>

In the first exemplary embodiment, the multiplication with the 1-bit filter weight is substituted with a bit operation, but the present disclosure is not limited to a bit operation. The multiplication can be performed by a multiplier or a multiplexer (selector) without being substituted with a bit operation.

If the variable m is set to 0, the feature data is expressed in two's complement, and the multiply-accumulate operation formula in the case where the filter weight w has a value of −1 is as in Equation 10:

$${\sum }_{i = 0}^{l - 1} [ {\sum }_{j = 0}^{J - 1} ( {2}^{j} \cdot \overline{{a}_{i , j}^{′}} ) + 1 ] + β = {\sum }_{i = 0}^{l - 1} {\sum }_{j = 0}^{J - 1} ( {2}^{j} \cdot \overline{{a}_{i , j}^{′}} ) + l + β \qquad ( Equation 10 )$$

The overline of a variable a′ means logical inverse (NOT). The result of the logical inverse includes a sign bit. It is necessary to handle overflow, truncation, and so on, but they are omitted in Equation 10. In this case, the correction value indicates the number I of filter weights.

When the filter weight w has a value of 1, the logical inverse is not required, and the correction value is 0. It means that the correction value is equal to the number of filter weights whose values are −1. As illustrated in FIG. 7, in order to improve the processing speed, it is necessary to increase the parallelism of the circuit that performs multiply-accumulate processing on a plurality of pixels, but it is not necessary to increase the parallelism of the circuit that calculates the correction value.

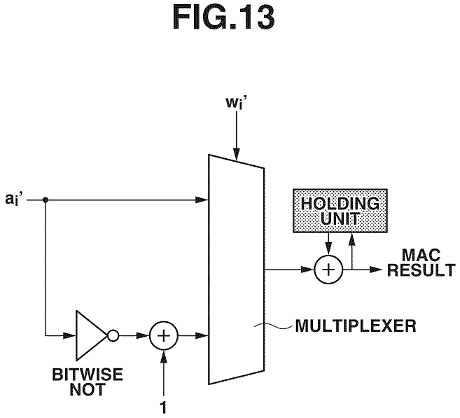

FIG. 13 illustrates an example in which multiplication is replaced by a multiplexer or the like. Positive feature data and negative feature data are selected. The calculation result of Equation 10 can be output.

### <Calculating Correction Value Outside Inference Apparatus>

In the first and second exemplary embodiments, the correction value is calculated inside the apparatus. Alternatively, the correction value may be calculated outside the apparatus. In this case, the correction value is included in the network structure information.

Unlike in the second exemplary embodiment, in the present exemplary embodiment, the correction value and the updated value of bias β′ are calculated in advance outside the apparatus in accordance with Equation 8. In step S801, instead of calculating the correction value, the filter weight and new network structure information 409 are read from the RAM 308, and the bias β′ including the correction value is stored in the memory 402.

In the present exemplary embodiment, the correction value is calculated by an external device and stored in the holding unit together with the network structure information, so that there is no need to calculate the correction value inside the apparatus, and the circuit size can be reduced.

The present disclosure can reduce the circuit size in performing multiply-accumulate processing on feature data of 2 bits or more using a 1-bit filter weight in neural network processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-180642, filed Oct. 19, 2023, which is hereby incorporated by reference herein in its entirety.

What is claimed is:

1. An inference processing apparatus comprising:
a multiply-accumulate processing unit configured to, in a neural network having a plurality of layers, output a result of multiply-accumulate processing on data of a plurality of feature maps and a 1-bit filter weight; and
an adding unit configured to add a correction value for correcting the result of the multiply-accumulate processing to the result of the multiply-accumulate processing, the correction value being independent of the data of the feature maps.

2. The inference processing apparatus according to claim 1, further comprising a correction unit configured to calculate the correction value independently of the multiply-accumulate processing unit.

3. The inference processing apparatus according to claim 2, wherein the correction unit processes a smaller number of pieces of data in parallel than the multiply-accumulate processing unit.

4. The inference processing apparatus according to claim 1, further comprising a holding unit,
wherein the holding unit holds the correction value calculated by an external device and neural network structure information.

5. The inference processing apparatus according to claim 1, further comprising a holding unit,
wherein the holding unit holds the correction value calculated before the multiply-accumulate processing is performed,
wherein the adding unit reads out the correction value from the holding unit and performs addition, and
wherein the inference processing apparatus does not comprise a correction unit configured to calculate the correction value.

6. The inference processing apparatus according to claim 1, wherein the filter weight has values of +1 and −1, or 0 and +1.

7. The inference processing apparatus according to claim 1, wherein, among the layers, the filter weight used by the multiply-accumulate processing unit has different values of a mode of +1 and −1 and a mode of 0 and +1.

8. The inference processing apparatus according to claim 1, wherein the multiply-accumulate processing unit calculates a multiplication result by a bit logical operation.

9. The inference processing apparatus according to claim 1, wherein, in a bit logical operation, a 1-bit logical operation is performed for each digit value of a binarized data of the feature maps.

10. The inference processing apparatus according to claim 2,
wherein the correction unit calculates the correction value using the filter weight, and
wherein the adding unit calculates a sum of the multiply-accumulate processing result and the correction value.

11. The inference processing apparatus according to claim 1, wherein the correction value includes a bias.

12. The inference processing apparatus according to claim 1, wherein the multiply-accumulate processing unit performs multiplication by a bit logical operation unit, and outputs either a logical product (AND) or an exclusive logical sum (XOR) in accordance with neural network structure information.

13. The inference processing apparatus according to claim 10, wherein the correction value varies depending on whether an output of a bit logical operation unit is a logical product (AND) or an exclusive logical sum (XOR).

14. The inference processing apparatus according to claim 10, wherein a bit logical operation unit outputs either a logical product (AND) or an exclusive logical sum (XOR) in accordance with neural network structure information.
